(19) United States
(12) Patent Application Publication
(10) Pub. No.: US 2019/0161090 A1
(43) Pub. Date: May 30, 2019

(54) VEHICLE CONTROL DEVICE, VEHICLE CONTROL METHOD, AND RECORDING MEDIUM

(71) Applicant: HONDA MOTOR CO., LTD., Tokyo (JP)

(72) Inventors: Hiroshi Miura, Wako-shi (JP); Makoto Ishikawa, Wako-shi (JP); Masamitsu Tsuchiya, Wako-shi (JP); Koji Kawabe, Wako-shi (JP)

(21) Appl. No.: 16/188,342

(22) Filed: Nov. 13, 2018

(30) Foreign Application Priority Data
Nov. 27, 2017 (JP) 2017-227172

(51) Int. Cl. B60W 50/02; G05D 1/00; B60W 30/14

(52) U.S. Cl. CPC B60W 50/0205; G05D 1/0088; B60W 30/143; B60W 50/0225; G05D 2201/0213; B60W 2050/0014; B60W 2550/12; B60W 2550/14; B60W 2550/308; B60W 2720/106; B60W 2420/42

(57) ABSTRACT

A vehicle control device includes a recognizer configured to recognize a preceding vehicle that is in front of a subject vehicle on the basis of information collected by an information collection unit including an information collection surface oriented toward an outside of the subject vehicle, a determiner configured to determine whether or not a situation in front of the subject vehicle satisfies a predetermined condition on the basis of a recognition result by the recognizer, and determine that a minute object on a road that is being flung up by the preceding vehicle affects a recognition accuracy of the recognizer by adhering to the information collection surface in a case where the situation in front of the subject vehicle satisfies the predetermined condition, and a driving controller configured to control a speed of the subject vehicle to increase a relative distance between the subject vehicle and the preceding vehicle in a case where it is determined by the determiner that the minute object on the road that is being flung up by the preceding vehicle affects the recognition accuracy of the preceding vehicle by adhering to the information collection surface.

### CROSS-REFERENCE TO RELATED APPLICATION

Priority is claimed on Japanese Patent Application No. 2017-227172, filed Nov. 27, 2017, the content of which is incorporated herein by reference.

### BACKGROUND OF THE INVENTION

### Field of the Invention

The present invention relates to a vehicle control device, a vehicle control method, and a storage medium.

### Description of Related Art

Conventionally, a system in which contamination of an in-vehicle optical sensor is cleaned by spraying a cleaning liquid from a cleaning liquid nozzle is known (for example, refer to Japanese Unexamined Patent Application, First Publication No. 2014-19403).

### SUMMARY OF THE INVENTION

However, in a case where contamination is not cleaned by a cleaning liquid and the contamination remains, since detection ability of a sensor is lowered, there are cases where automated driving is not able to be continued. In a case where such an apparatus is provided in a vehicle, aerodynamic loss is large and problems are also significant in terms of maintaining strength.

An aspect of the present invention has been made in consideration of such circumstances, and an object of the aspect of the present invention is to provide a vehicle control device, a vehicle control method, and a storage medium capable of devising control for preventing contamination of an in-vehicle sensor.

A vehicle control device, a vehicle control method, and a storage medium according to the present invention adopt the following constitutions.

(1): A vehicle control device according to an aspect of the present invention includes a recognizer configured to recognize a preceding vehicle that is in front of a subject vehicle on the basis of information collected by an information collection unit including an information collection surface oriented toward an outside of the subject vehicle, a determiner configured to determine whether or not a situation in front of the subject vehicle satisfies a predetermined condition on the basis of a recognition result by the recognizer, and determine that a minute object on a road that is being flung up by the preceding vehicle affects a recognition accuracy of the recognizer by adhering to the information collection surface in a case where the situation in front of the subject vehicle satisfies the predetermined condition, and a driving controller configured to control a speed of the subject vehicle to increase a relative distance between the subject vehicle and the preceding vehicle in a case where it is determined by the determiner that the minute object on the road that is being flung up by the preceding vehicle affects the recognition accuracy of the preceding vehicle by adhering to the information collection surface.

(2): In the aspect of (1) described above, the vehicle control device further includes an acquirer configured to acquire weather information of a region in which the subject vehicle is present, and the determiner further determines whether or not the minute object on the road that is being flung up by the preceding vehicle affects the recognizer on the basis of the weather information acquired by the acquirer.

(3): In the aspect of (2) described above, the determiner determines whether or not a recognition ability by the recognizer in the future will be reduced by the flung-up minute object on the basis of the weather information, and in a case where it is determined by the determiner that the recognition ability by the recognizer in the future will be reduced by the flung-up minute object, the driving controller controls the speed of the subject vehicle to increase the relative distance.

(4): In the aspect of (1) described above, the recognizer further recognizes a state of a road surface, and in a case where it is recognized by the recognizer that the road surface is wet and it is not raining, the determiner determines that the minute object on the road that is being flung up by the preceding vehicle affects the recognizer.

(5): In the aspect of (1) described above, in a case where a recognition ability by the recognizer is less than a threshold value, the determiner determines that the minute object on the road that is being flung up by the preceding vehicle affects the recognizer.

(6): In the aspect of (1) described above, the determiner determines whether or not precipitation has just ended and determines whether or not precipitation is ongoing on the basis of weather information of a region in which the subject vehicle is present, and in a case where it is determined by the determiner that the minute object on the road that is being flung up by the preceding vehicle affects the recognizer and precipitation has just ended, the driving controller controls the speed of the subject vehicle to increase the relative distance between the subject vehicle and the preceding vehicle as compared with a case where it is determined that the minute object on the road that is being flung up by the preceding vehicle affects the recognizer and precipitation is ongoing.

(7): A vehicle control device according to an aspect of the present invention includes a recognizer configured to recognize a preceding vehicle in front of a subject vehicle and a state of a road surface on the basis of information collected by an information collection unit including an information collection surface oriented toward an outside of the subject vehicle, an acquirer configured to acquire weather information of a region in which the subject vehicle is present, and a driving controller configured to control a speed of the subject vehicle to increase a relative distance between the subject vehicle and the preceding vehicle in a case where it is recognized by the recognizer that the road surface is wet and it is not raining, as compared with a case where it is not recognized by the recognizer that the road surface is wet or it is raining.

(8): A vehicle control method according to an aspect of the present invention is a method executed by an in-vehicle computer that is mounted in a vehicle. The vehicle control method by the in-vehicle computer includes recognizing a preceding vehicle in front of a subject vehicle on the basis of information collected by an information collection unit including an information collection surface oriented toward an outside of the subject vehicle, determining whether or not a situation in front of the subject vehicle satisfies a predetermined condition on the basis of a recognition result, determining that a minute object on a road that is being flung up by the preceding vehicle affects a recognition accuracy of the preceding vehicle by adhering to the information collection surface in a case where the situation in front of the subject vehicle satisfies the predetermined condition, and controlling a speed of the subject vehicle to increase a relative distance between the subject vehicle and the preceding vehicle in a case where it is determined that the minute object on the road that is being flung up by the preceding vehicle affects the recognition accuracy of the preceding vehicle by adhering to the information collection surface.

(9): A storage medium according to an aspect of the present invention is a computer-readable non-transitory storage medium storing a program that causes an in-vehicle computer to recognize a preceding vehicle in front of a subject vehicle on the basis of information collected by an information collection unit including an information collection surface oriented toward an outside of the subject vehicle, determine whether or not a situation in front of the subject vehicle satisfies a predetermined condition on the basis of a recognition result, determine that a minute object on a road that is being flung up by the preceding vehicle affects a recognition accuracy of the preceding vehicle by adhering to the information collection surface in a case where the situation in front of the subject vehicle satisfies the predetermined condition, and control a speed of the subject vehicle to increase a relative distance between the subject vehicle and the preceding vehicle in a case where it is determined that the minute object on the road that is being flung up by the preceding vehicle affects the recognition accuracy of the preceding vehicle by adhering to the information collection surface.

According to the aspects of (1) to (9) described above, it is possible to devise control for preventing an in-vehicle sensor from being contaminated.

### BRIEF DESCRIPTION OF THE DRAWINGS

FIG. 1 is a constitution diagram of a vehicle system using a vehicle control device according to a first embodiment.

FIG. 2 is a functional constitution diagram of a first controller and a second controller.

FIG. 3 is a diagram illustrating an aspect in which a target trajectory is generated on the basis of a recommended lane.

FIG. 4 is an example of an image captured by a camera.

FIG. 5 is a flowchart illustrating an example of a flow of a first determination process executed by the first controller.

FIG. 6 is a flowchart illustrating an example of a flow of a second determination process executed by the first controller.

FIG. 7 is a flowchart illustrating an example of a flow of a third determination process executed by the first controller.

FIG. 8 is a flowchart illustrating an example of a flow of a fourth determination process executed by the first controller.

FIG. 9 is a flowchart illustrating an example of a flow of a fifth determination process executed by the first controller.

FIG. 10 is a flowchart illustrating an example of a flow of a sixth determination process executed by the first controller.

FIG. 11 is a flowchart illustrating an example of a flow of a seventh determination process executed by the first controller.

FIG. 12 is a flowchart illustrating an example of a flow of an eighth determination process executed by the first controller.

FIG. 13 is a functional constitution diagram of an automated driving control device according to a second embodiment.

FIG. 14 is a flowchart illustrating an example of a flow of a ninth determination process executed by the first controller.

FIG. 15 is a constitution diagram of a vehicle system using the vehicle control device according to a third embodiment.

FIG. 16 is a diagram illustrating an example of a hardware constitution of the vehicle control device according to each embodiment.

### DETAILED DESCRIPTION OF THE INVENTION

### First Embodiment

Hereinafter, embodiments of a vehicle control device, a vehicle control method, and a storage medium of the present invention will be described with reference to the drawings. A case where left-side driving is applied to the present invention will be described below, but in a case where right-side is applied to the present invention, it is only necessary to reverse left and right.

[Overall Constitution]

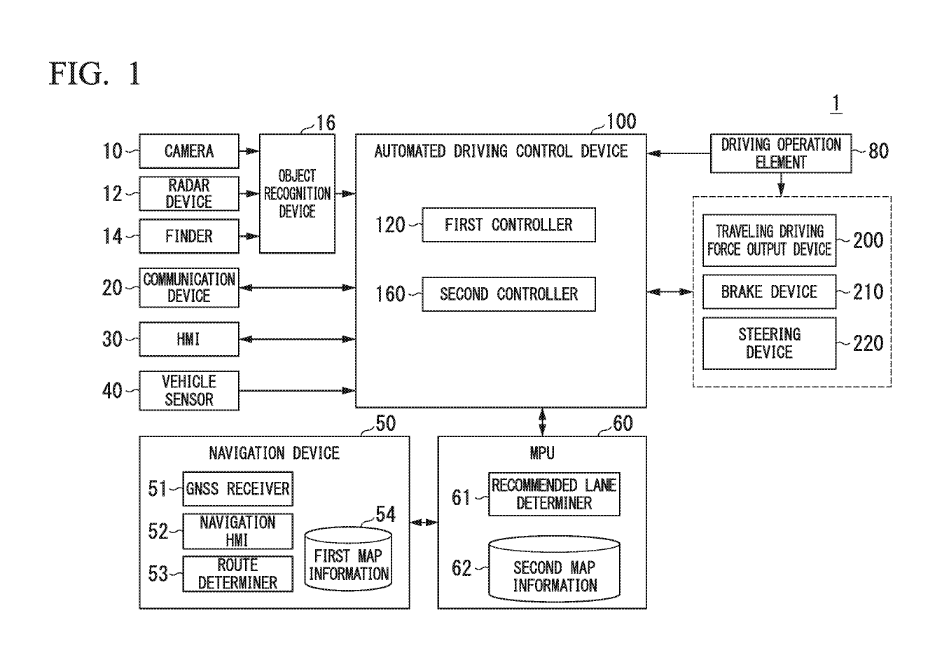

FIG. 1 is a constitution diagram of a vehicle system 1 using the vehicle control device according to the embodiment. A vehicle in which the vehicle system 1 is mounted is, for example, a vehicle such as a two-wheeled vehicle, a three-wheeled vehicle, or a four-wheeled vehicle, and a driving source of the vehicle is an internal combustion engine such as a diesel engine or a gasoline engine, an electric motor, or a combination thereof. In a case where the electric motor is provided, the electric motor operates using electric power generated by a generator connected to the internal combustion engine or electric power discharged by a secondary battery or a fuel cell.

For example, the vehicle system 1 includes a camera 10, a radar device 12, a finder 14, an object recognition device 16, a communication device 20, a human machine interface (HMI) 30, a vehicle sensor 40, a navigation device 50, a map positioning unit (MPU) 60, a driving operation element 80, an automated driving control device 100, a traveling driving force output device 200, a brake device 210, and a steering device 220. Such devices and instruments are connected to each other by a multiplex communication line such as a controller area network (CAN) communication line, a serial communication line, a wireless communication network, or the like. The constitution shown in FIG. 1 is merely an example, and a part of the constitution may be omitted or other constitutions may be further added.

For example, the camera 10 is a digital camera using a solid imaging element such as a charge coupled device (CCD) or a complementary metal oxide semiconductor (CMOS). One or a plurality of cameras 10 are attached to arbitrary places on the vehicle in which the vehicle system 1 is mounted (hereinafter referred to as the subject vehicle M). In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. One or a plurality of radar devices 12 are attached to arbitrary places on the subject vehicle M. The radar device 12 may detect the position and the speed of the object by a frequency modulated continuous wave (FM-CW) method.

The finder 14 is a light detection and ranging (LIDAR). The finder 14 irradiates light around the subject vehicle M and measures scattered light. The finder 14 detects the distance to the object on the basis of a time from light emission to light reception. For example, the irradiated light is laser light of a pulse shape. One or a plurality of finders 14 are attached to arbitrary places on the subject vehicle M.

The object recognition device 16 performs a sensor fusion process on a detection result of some or all of the camera 10, the radar device 12, and the finder 14 to recognize a position, a type, a speed, and the like of the object. The object recognition device 16 outputs a recognition result to the automated driving control device 100. The object recognition device 16 may output the detection result of the camera 10, the radar device 12, and the finder 14 as they are to the automated driving control device 100 as occasion demands. The speed acquirer may include the radar device 12.

For example, the communication device 20 communicates with another vehicle near the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

The vehicle sensor 40 includes a vehicle speed sensor that detects a speed of the subject vehicle M, an acceleration sensor that detects acceleration, a yaw rate sensor that detects an angular velocity around a vertical axis, a direction sensor that detects a direction of the subject vehicle M, and the like.

For example, the navigation device 50 includes a global navigation satellite system (GNSS) receiver 51, a navigation HMI 52, and a route determiner 53, and holds first map information 54 in a storage device such as a hard disk drive (HDD) or a flash memory. The GNSS receiver 51 specifies the position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, a key, and the like. A part or all of the navigation HMI 52 may be shared with the above-described HMI 30. For example, the route determiner 53 determines a route (hereinafter referred to as a route on a map) from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route on the map determined by the route determiner 53 is output to the MPU 60. The navigation device 50 may perform route guidance using the navigation HMI 52 on the basis of the route on the map determined by the route determiner 53. For example, the navigation device 50 may be realized by a function of a terminal device such as a smartphone or a tablet terminal possessed by the user. The navigation device 50 may transmit a current position and a destination to a navigation server through the communication device 20 and acquire the route on the map returned from the navigation server.

For example, the MPU 60 functions as a recommended lane determiner 61 and holds second map information 62 in the storage device such as an HDD or a flash memory. The recommended lane determiner 61 divides the route provided from the navigation device 50 into a plurality of blocks (for example, divides the route into intervals of 100 [m] in a vehicle traveling direction), and determines a recommended lane for each block by referring to the second map information 62. The recommended lane determiner 61 determines the number of a lane from the left that the vehicle travels in.

In a case where there is a branching position, a merging position, or the like on the route, the recommended lane determiner 61 determines the recommended lane so that the subject vehicle M is able to travel on a reasonable travel route for progressing to a branch destination.

The second map information 62 is map information with higher accuracy than the first map information 54. For example, the second map information 62 may include information on the center of a lane, information on a boundary of a lane, or the like. The second map information 62 may include road information, traffic regulation information, address information (an address and a postal code), facility information, telephone number information, and the like. The second map information 62 may be updated at any time by accessing another device using the communication device 20.

The driving operation element 80 includes, for example, an acceleration pedal, a brake pedal, a shift lever, a steering wheel, a modified steering wheel, a joystick, and other operation elements. A sensor that detects an operation amount or presence or absence of an operation is attached to the driving operation element 80, and a detection result of the sensor is output to at least one or all of the automated driving control device 100, or the traveling driving force output device 200, the brake device 210, and the steering device 220.

For example, the automated driving control device 100 includes a first controller 120 and a second controller 160. For example, each of the first controller 120 and the second controller 160 is realized by a hardware processor such as a central processing unit (CPU) executing a program (software). Some or all of such constitution elements may be realized by hardware (a circuit unit including a circuitry) such as a large scale integration (LSI), an application specific integrated circuit (ASIC), a field-programmable gate array (FPGA), or a graphic processing unit (GPU), or may be realized by software and hardware in cooperation. The program may be stored in a storage device such as a hard disk drive (HDD) or a flash memory in advance. Alternatively, the program may be stored in a detachable storage medium such as a DVD or a CD-ROM and may be installed in a storage device by attachment of the storage medium to a drive device.

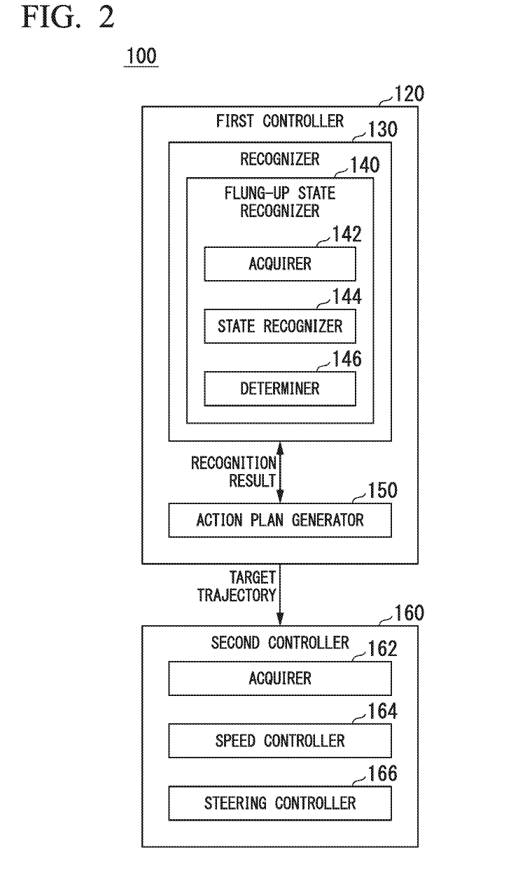

FIG. 2 is a functional constitution diagram of the first controller 120 and the second controller 160. For example, the first controller 120 includes a recognizer 130 and an action plan generator 150. For example, the first controller 120 realizes a function of artificial intelligence (AI) and a function of a previously given model in parallel. For example, a function of “recognizing an intersection” is executed in parallel with recognition of an intersection by deep learning or the like and recognition based on a previously given condition (there is a pattern matching signal, a road sign, or the like) and is realized by giving scores to both sides and comprehensively evaluating the scores. Therefore, reliability of automated driving is guaranteed.

The recognizer 130 recognizes states such as the position, the speed and the acceleration of the object near the subject vehicle M, on the basis of information input from the camera 10, the radar device 12, and the finder 14 through the object recognition device 16. The camera 10, the radar device 12, and the finder 14 are examples of an information collection unit including an information collection surface oriented toward an outside of the subject vehicle M. For example, the position of the object is recognized as a position in absolute coordinates using a representative point (a center of gravity, a drive shaft center, or the like) of the subject vehicle M as an origin and is used in control. The position of the object may be represented by the representative point such as the center of gravity or a corner of the object, or may be represented by an expressed region. A “state” of the object may include both of an acceleration and a jerk of the object, or an “action state” (for example, whether or not the object is changing lanes or about to change lanes). The recognizer 130 recognizes a shape of a curve on which the subject vehicle M is about to pass on the basis of the captured image of the camera 10. The recognizer 130 converts the shape of the curve from the captured image of the camera 10 to a real plane, and for example, the recognizer 130 outputs information expressed using two-dimensional point row information or an equivalent model the same as the two-dimensional point row information to the action plan generator 150 as information indicating the shape of the curve.

For example, the recognizer 130 recognizes a lane in which the subject vehicle M is traveling (a traveling lane). A recognition result of the lane indicates, for example, the lane in which the subject vehicle M is traveling among a plurality of lanes in the same traveling direction. In a case in which there is one lane, that fact may be the recognition result. For example, the recognizer 130 recognizes the traveling lane by comparing a pattern of a road lane marking (for example, an arrangement of a solid line and a broken line) obtained from the second map information 62 with a pattern of a road lane marking near the subject vehicle M recognized from the image captured by the camera 10. The recognizer 130 may recognize the traveling lane by recognizing a traveling road boundary (a road boundary) including a road lane marking, a road shoulder, a curb, a median strip, a guardrail, and the like, and is not limited to recognizing road lane markings. In this recognition, the position of the subject vehicle M acquired from the navigation device 50 or a process result by an INS may be added. The recognizer 130 recognizes a temporary stop line, an obstacle, a red light, a toll gate, and other road events.

When recognizing the traveling lane, the recognizer 130 recognizes the position and a posture of the subject vehicle M with respect to the traveling lane. For example, the recognizer 130 may recognize an angle formed by a deviation of a reference point of the subject vehicle M from a center of the lane and a line connecting the center of the lane of a traveling direction of the subject vehicle M as a relative position and the posture of the subject vehicle M with respect to the traveling lane. Instead of this, the recognizer 130 may recognize a position of the reference point of the subject vehicle M with respect to one of side end portions (the road lane marking or the road boundary) of the traveling lane as the relative position of the subject vehicle M with respect to the traveling lane.

In the recognition process described above, the recognizer 130 may derive a recognition accuracy and output the recognition accuracy as recognition accuracy information to the action plan generator 150. For example, the recognizer 130 generates the recognition accuracy information on the basis of a frequency of recognition of the road lane markings in a certain period.

The recognizer 130 includes a flung-up state recognizer 140. The flung-up state recognizer 140 includes an acquirer 142, a state recognizer 144, and a determiner 146. These constitutions will be described later.

In principle, the action plan generator 150 determines the events to be sequentially executed in the automated driving so that the subject vehicle M travels in the recommended lane determined by the recommended lane determiner 61 and further responds to the surrounding situation of the subject vehicle M. The events include, for example, a constant-speed traveling event in which the subject vehicle M travels in the same traveling lane at a constant speed, a follow-up traveling event in which the subject vehicle M follows the preceding vehicle m, an overtaking event in which the subject vehicle M overtakes the preceding vehicle, an avoidance event in which the subject vehicle M performs braking and/or steering to avoid approaching an obstacle, a curve traveling event in which the subject vehicle M travels on a curve, a passing event in which the subject vehicle M passes through a predetermined point such as an intersection, a pedestrian crossing, or a railroad crossing, a lane change event, a merge event, a branch event, an automated stop event, and a takeover event for switching driving to the manual driving by ending the automated driving.

The action plan generator 150 generates a target trajectory in which the subject vehicle M will travel in the future according to an activated event. Details of each functional unit will be described later. The target trajectory includes, for example, a speed element. For example, the target trajectory is expressed as a sequence of points (trajectory points) that the subject vehicle M reaches. The trajectory points are points that the subject vehicle M reaches for each predetermined traveling distance (for example, about several [m]) at a road distance, and separately from that, a target speed and a target acceleration for each predetermined sampling time (for example, about several tenths of a[sec]) are generated as part of the target trajectory. The trajectory points may be positions that the subject vehicle M reaches at a sampling time for each predetermined sampling time. In this case, information on the target speed and the target acceleration is expressed by an interval between the trajectory points.

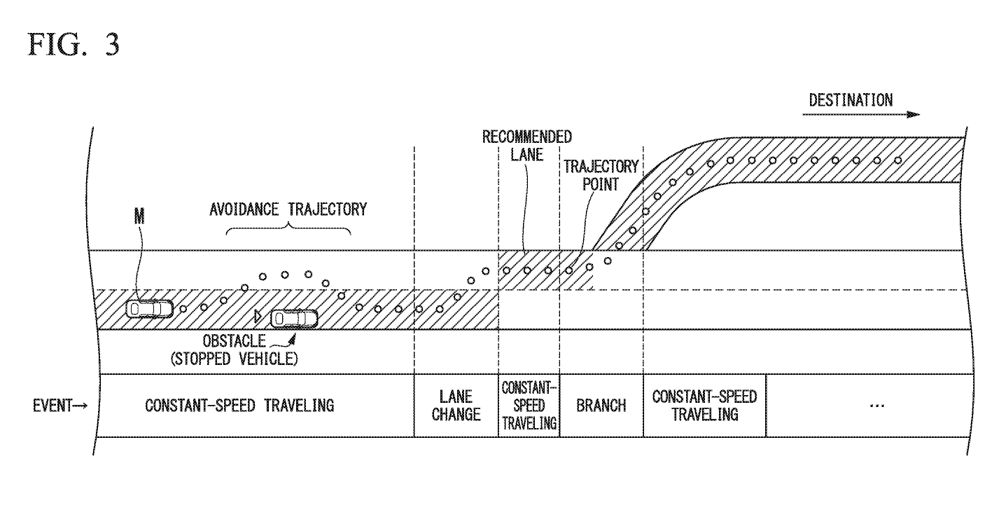

FIG. 3 is a diagram illustrating a situation in which the target trajectory is generated on the basis of the recommended lane. As shown in the drawing, the recommended lane is set so that traveling along the route to the destination is convenient.

The action plan generator 150 activates a passing event, a lane change event, a branch event, a merge event, or the like when approaching a predetermined distance (which may be determined according to a kind of event) at a switching point of the recommended lane. In a case where it is necessary to avoid an obstacle during the execution of each event, an avoidance trajectory is generated as shown in the drawing.

The second controller 160 controls the traveling driving force output device 200, the brake device 210, and the steering device 220 so that the subject vehicle M passes through the target trajectory generated by the action plan generator 150 at a scheduled time.

Returning to FIG. 2, for example, the second controller 160 includes an acquirer 162, a speed controller 164, and a steering controller 166. The acquirer 162 acquires information on the target trajectory (a trajectory point) generated by the action plan generator 150 and stores the information in a memory (not shown). The speed controller 164 controls the traveling driving force output device 200 or the brake device 210 on the basis of a speed element accompanying the target trajectory stored in the memory. The steering controller 166 controls the steering device 220 according to a degree of curvature of the target trajectory stored in the memory. For example, a process of the speed controller 164 and the steering controller 166 is realized by a combination of feed-forward control and feedback control. As an example, the steering controller 166 is executed by a combination of feed-forward control according to a curvature of the road ahead of the subject vehicle M and feedback control based on the deviation from the target trajectory.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and an ECU that controls the internal combustion engine, the electric motor, the transmission, and the like. The ECU controls the above-described constitutions according to the information input from the second controller 160 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the second controller 160 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. The brake device 210 is not limited to the constitution described above, and may be an electronic control method oil pressure brake device that controls an actuator according to the information input from the second controller 160 to transfer the oil pressure of the master cylinder to the cylinder.

For example, the steering device 220 includes a steering ECU and an electric motor.

For example, the electric motor changes a direction of steerable wheels by applying a force to a rack and pinion mechanism. The steering ECU changes the direction of the steerable wheels by driving the electric motor according to the information input from the second controller 160 or the information input from the driving operation element 80.

Next, each constitution of the flung-up state recognizer 140 included in the recognizer 130 will be described in detail.

The acquirer 142 acquires weather information of a region in which the subject vehicle M is present using the communication device 20. For example, the acquirer 142 transmits position information of the subject vehicle M acquired by the navigation device 50 to an external server and acquires the weather information from the external server, using the communication device 20. The weather information includes types of weather (rain, snow, sunny, cloudy, and the like), information indicating the amount of precipitation, and the like.

The acquirer 142 acquires information indicating a degree of recognition ability by the object recognition device 16. For example, in a case where the object recognized by the camera 10 and the object recognized by the finder 14 do not coincide with each other in the recognition result by the object recognition device 16, the acquirer 142 acquires information indicating that the recognition ability by the object recognition device 16 is lower than a reference level. The acquirer 142 may derive information indicating a level of decrease according to the number of times recognized objects do not coincide with each other in a certain period. In a case where the recognition result by the finder 14 is unnatural, the acquirer 142 may acquire the information indicating that the recognition ability by the object recognition device 16 is lower than the reference level. Cases where the recognition result by the finder 14 is unnatural include, for example, a case where the object is continuously recognized for a predetermined time or more in an immediate vicinity of the subject vehicle M, and the like. In the following description, since the recognition ability of the object recognition device 16 directly affects the recognition ability of the recognizer 130, both have substantially the same meaning.

The state recognizer 144 recognizes a state in front of the subject vehicle M on the basis of the image captured by the camera 10. The state in front includes a state in which a spray is rising in the vicinity of a tire of the preceding vehicle m, a state in which the road surface is wet or frozen, and the like. For example, the state recognizer 144 recognizes the state in front by using, for example, a machine learning method such as deep learning. The state recognizer 144 may recognize the state in front by a modeled method such as pattern matching or may execute the machine learning method and the modeled method in parallel. The state recognizer 144 outputs a recognition result to the determiner 146.

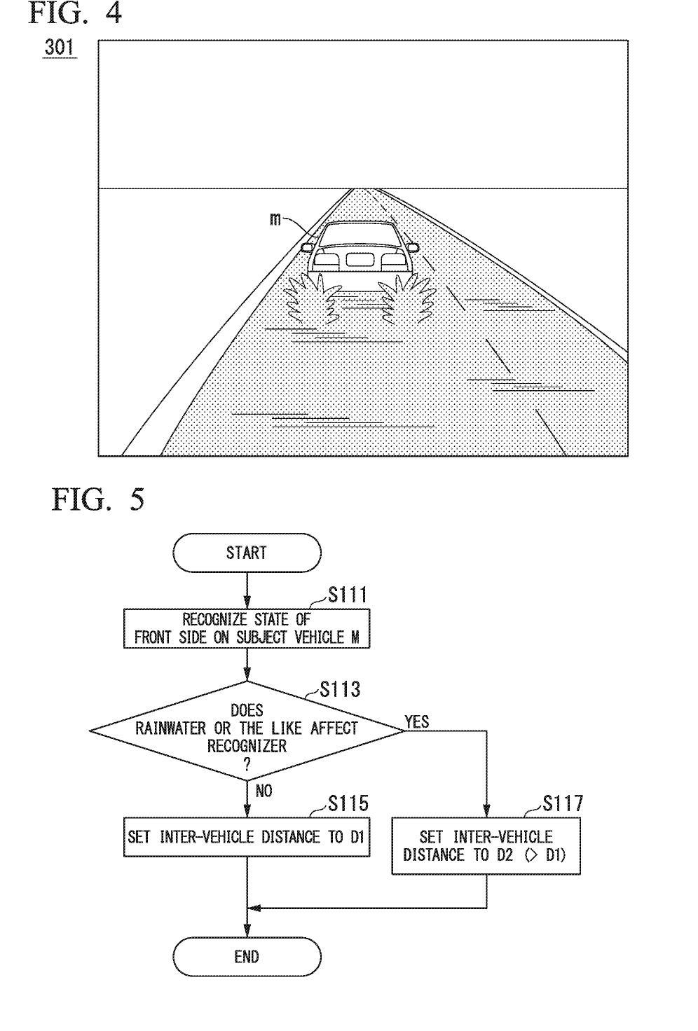

FIG. 4 is an example of an image 301 captured by the camera 10. The image 301 shows the preceding vehicle m traveling on a wet road surface. The preceding vehicle m is traveling while stirring up rain water or the like on the road surface. Therefore, the image 301 shows a situation in which spray is rising in the vicinity of the tire of the preceding vehicle m. The rainwater and the like that are being flung up by the preceding vehicle m includes mud, sand, dirt, and the like, and these are examples of minute objects that are being flung up by the preceding vehicle m. The state recognizer 144 recognizes that the road surface is wet and recognizes a state in which the spray is rising in the vicinity of the tire of the preceding vehicle m, on the basis of the image 301, using the method described above. In a case where the spray is rising in the vicinity of the tire of the preceding vehicle m, there is a possibility that it will be difficult to see the vicinity of the tire of the preceding vehicle due to the spray. In this case, in a case where the state recognizer 144 extracts an image of the preceding vehicle m from the image 301 and it is difficult to recognize the vicinity of the tire of the preceding vehicle m in the image 301, the state recognizer 144 may recognize the state in which the spray is rising in the vicinity of the tire of the preceding vehicle m.

The determiner 146 determines whether or not the rainwater or the like on the road that is being flung up by the preceding vehicle m affects the recognition accuracy of the recognizer 130 (including the object recognition device 16) by adhering to the information collection surface of the camera 10 or the like on the basis of the state of the front side on the subject vehicle M. “The rainwater or the like on the road that is being flung up by the preceding vehicle m affects the recognition accuracy of the recognizer 130” means that the rainwater or the like on the road that is being flung up by the preceding vehicle m affects the recognition accuracy of the recognizer 130 by adhering to the information collection surface of the camera 10 or the like. For example, as described above, in a case where the state in which the spray is rising in the vicinity of the tire of the preceding vehicle m is recognized by the state recognizer 144 (that is, in a case where the aspect of the front side on the subject vehicle M satisfied a predetermined condition), the determiner 146 determines that the rainwater or the like on the road that is being flung up by the preceding vehicle m affects the recognizer 130. In a case where a state in which the road surface is wet is recognized by the state recognizer 144 (that is, in a case where the aspect of the front side on the subject vehicle M satisfies a predetermined condition), the determiner 146 determines that the rainwater or the like on the road that is being flung up by the preceding vehicle m affects the recognizer 130.

The determiner 146 may determine whether or not the rainwater or the like on the road that is being flung up by the preceding vehicle m affects the recognizer 130 on the basis of the weather information acquired by the acquirer 142. For example, in a case where the weather in the region in which the vehicle M is present is during precipitation or immediately after precipitation (within a predetermined time after the rain has risen), it may be determined that the rainwater or the like on the road that is being flung up by the preceding vehicle m affects the recognizer 130. A time immediately after includes a time right (less than 5 minutes) after precipitation, a time for a while (less than 1 hour) after precipitation, by arbitrary setting a predetermined time after the rain rises.

In a case where the recognition ability by the object recognition device 16 is lower than the reference level (or the degree of the recognition ability is equal to or less than the threshold value) on the basis of the information indicating the degree of the recognition ability by the object recognition device 16 acquired by the acquirer 142, the determiner 146 determines that the rainwater or the like on the road that is being flung up by the preceding vehicle m affects the recognizer 130.

In a case where any one of the condition or a plurality of conditions are satisfied among the determination methods described above, the determiner 146 may determine that the rainwater or the like on the road that is being flung up by the preceding vehicle m affects the recognizer 130. For example, even in a case where it is not raining in the region in which the subject vehicle M is present on the basis of the weather information, the determiner 146 may determine that the rainwater or the like on the road that is being flung up by the preceding vehicle m affects the recognizer 130 in a case where the state in which the road surface is wet is recognized by the state recognizer 144.

The determiner 146 may determine whether or not the recognition ability of the recognizer 130 in the future will be reduced due to the flung-up rainwater or the like, on the basis of the weather information acquired by the acquirer 142. For example, in a case where the amount of precipitation is within a predetermined range (for example, less than 5 to 20 mm/h that is a range of weak rain to somewhat strong rain), a possibility that the rainwater or the like flung up by the preceding vehicle m reduces the recognition ability by adhering to a detection surface of the finder 14 is high. On the other hand, in a case where the amount of precipitation is equal to or more than the predetermined range (for example, 20 to 30 mm/h or more that is a pouring range), since it is difficult for the flung-up rainwater or the like to be adhered to the finder 14 and there is a case the falling rain sometimes washes away the detection surface of the finder 14, a possibility that the recognition ability is reduced is low. Therefore, in a case where the amount of precipitation is within the predetermined range, the determiner 146 determines that the recognition ability of the recognizer 130 in the future will be reduced due to the flung-up rainwater or the like. On the other hand, in a case where the amount of precipitation is equal to or more than the predetermined range, the determiner 146 determines that the recognition ability of the recognizer 130 in the future will not be reduced due to the flung-up rainwater or the like.

Next, flung up avoidance control by the action plan generator 150 will be described in detail. When various events are being executed, the action plan generator 150 adjusts the relative distance (hereinafter, referred to as an inter-vehicle distance) between the subject vehicle M and the preceding vehicle m on the basis of a determination result of the determiner 146.

For example, in a case where it is determined that the rainwater or the like on the road that is being flung up by the preceding vehicle m affects the recognizer 130 by the determiner 146, the action plan generator 150 controls the speed of the subject vehicle M so as to increase the inter-vehicle distance between the subject vehicle M and the preceding vehicle m as compared with a case where it is not determined that the rainwater or the like on the road that is being flung up by the preceding vehicle m affects the recognizer 130. For example, in a case where the action plan generator 150 is performing control to keep the distance to the preceding vehicle m constant, the action plan generator 150 sets the inter-vehicle distance of the case where it is determined that the rainwater or the like on the road that is being flung up by the preceding vehicle m affects the recognizer 130 to D1, and sets the inter-vehicle distance of the case where it is not determined that the rainwater or the like on the road that is being flung up by the preceding vehicle m affects the recognizer 130 to D2 larger than D1. Even in a case where the action plan generator 150 is not performing control to keep the inter-vehicle distance constant, the action plan generator 150 executes the deceleration control so as to make the inter-vehicle distance with the preceding vehicle m approaching within the predetermined distance to be secured, may continuously execute the deceleration control so that a measured inter-vehicle distance is equal to or greater than a set inter-vehicle distance, or may switch to control (constant control of the inter-vehicle distance) to maintain the set inter-vehicle distance.

In a case where it is determined that the rainwater or the like on the road that is being flung up by the preceding vehicle m affects the recognizer 130, the action plan generator 150 may set inter-vehicle distances different to each other according to the weather and a road surface situation of the region in which the subject vehicle M is present. For example, in a case where it is raining, the action plan generator 150 may set the inter-vehicle distance D3 (D3>D1), and immediately after the rain stops or in a case where the rain stops but the road surface is wet, the action plan generator 150 may set the inter-vehicle distance D4 (D4>D3>D1).

In a case where it is determined that the recognition ability by the recognizer 130 in the future will be reduced due to the flung-up rainwater or the like by the determiner 146, the action plan generator 150 may control the speed of the subject vehicle M so as to increase the inter-vehicle distance in advance. For example, in a case where it is determined that the recognition ability by the recognizer 130 in the future will be reduced due to the flung-up rainwater or the like by the determiner 146, the action plan generator 150 sets the distance D5 larger than D1 to the inter-vehicle distance. D5 may be the same value as D2 or may be smaller than D2. Next, a process example by the first controller 120 will be described with reference to FIGS. 5 to 12. FIGS. 5 to 10 are flowcharts illustrating an example of a flow of a process executed by the first controller 120. The process of FIGS. 5 to 12 is executed, for example, at timing when the preceding vehicle m is recognized by the recognizer 130. The first controller 120 sets the inter-vehicle distance by any of the processes of FIGS. 5 to 12.

An example of a first determination process by the first controller 120 will be described with reference to FIG. 5. First, the state recognizer 144 recognizes the state of the front side on the subject vehicle M (step S111). The determiner 146 determines whether or not the rainwater or the like on the road that is being flung up by the preceding vehicle m affects the recognizer 130 on the basis of the recognition result by the state recognizer 144 (step S113). In a case where the state in which the spray is rising in the vicinity of the tire of the preceding vehicle m is not recognized (or in a case where the state in which the road surface is wet is not recognized) by the state recognizer 144, the determiner 146 determines that the rainwater or the like on the road that is being flung up by the preceding vehicle m does not affect the recognizer 130. The action plan generator 150 sets the inter-vehicle distance to the preceding vehicle m to D1 on the basis of the determination result of the determiner 146 (step S115). On the other hand, in step 5113, in a case where the state in which the spray is rising in the vicinity of the tire of the preceding vehicle m is recognized (or in a case where the state in which the road surface is wet is recognized) by the state recognizer 144, the determiner 146 determines that the rainwater or the like on the road that is being flung up by the preceding vehicle m affects the recognizer 130. The action plan generator 150 sets the inter-vehicle distance to the preceding vehicle m to D2 larger than D1 on the basis of the determination result by the determiner 146 (step S117). It is possible to simply determine whether or not the rainwater or the like on the road that is being flung up by the preceding vehicle m affects the recognizer 130 on the basis of a situation in which the rainwater or the like is actually being flung up by the preceding vehicle m or a situation in which a possibility that the rainwater or the like is being flung up by the preceding vehicle m is high, by using the first determination process.

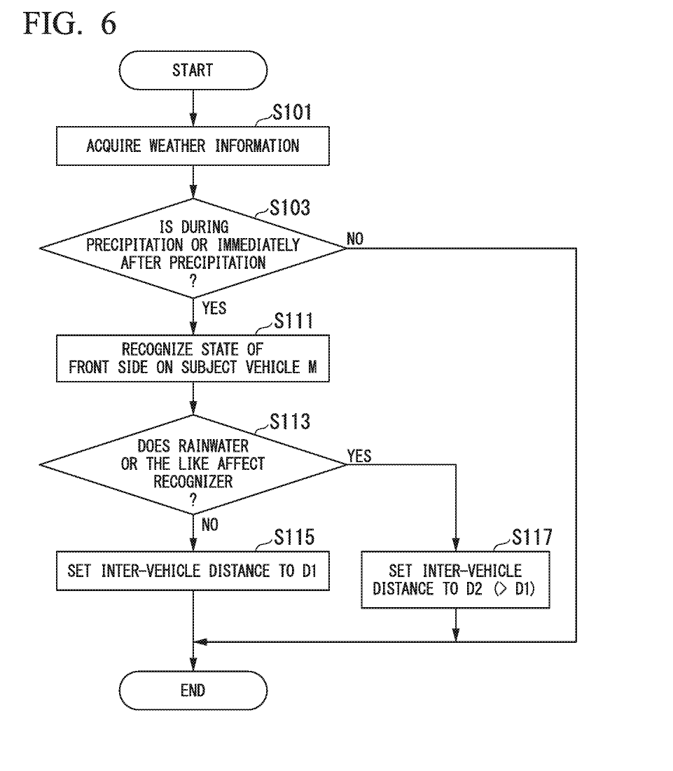

Next, an example of a second determination process by the first controller 120 will be described with reference to FIG. 6. The same processes as those in the first determination process are denoted by the same reference numerals, and a detailed description thereof will be omitted. First, the acquirer 142 acquires the weather information of the region in which the subject vehicle M is present (step S101). Then, the determiner 146 determines whether or not the region in which the subject vehicle M is present is during precipitation or immediately after precipitation on the basis of the weather information acquired by the acquirer 142 (step S103). In a case where it is determined that the region in which the subject vehicle M is present is not during precipitation or immediately after precipitation, the determiner 146 ends the process. On the other hand, in a case where it is determined that the region in which the subject vehicle M is present is during precipitation or immediately after precipitation, the state recognizer 144 recognizes the state of the front side on the subject vehicle M (step S111). Thereafter, the determiner 146 and the action plan generator 150 execute the same process as the first determination process. It is possible to determine whether the rainwater or the like on the road that is being flung up by the preceding vehicle m affects the recognizer 130 due to the weather by using the second determination process.

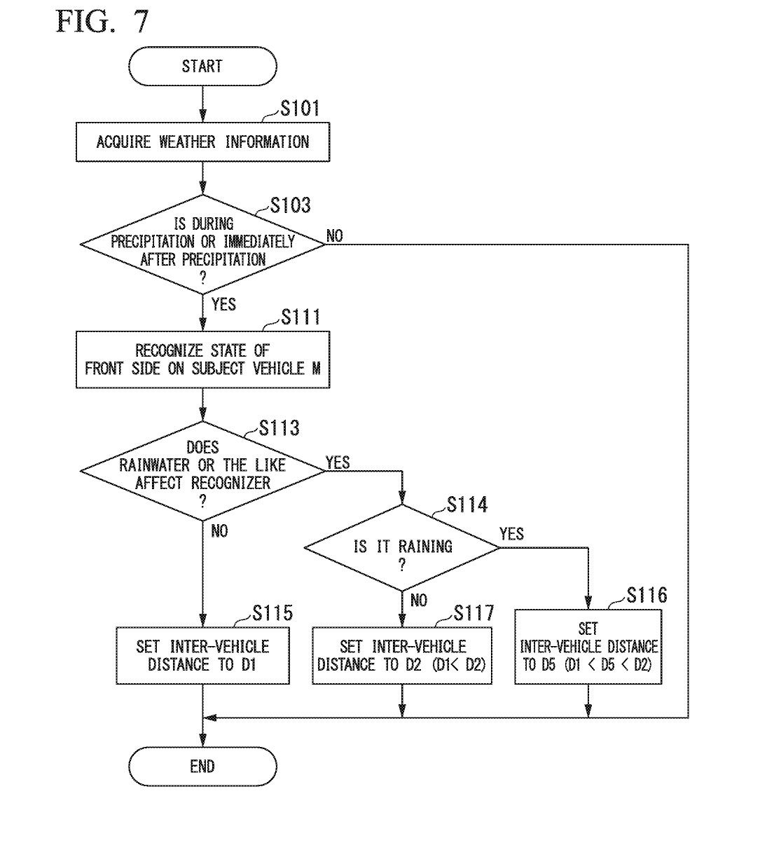

Next, an example of a third determination process by the first controller 120 will be described with reference to FIG. 7. The same processes as those in the second determination process are denoted by the same reference numerals, and a detailed description thereof will be omitted. In step S113, in a case where the state in which the spray is rising in the vicinity of the tire of the preceding vehicle m is recognized (or in a case where the state in which the road surface is wet is recognized) by the state recognizer 144, the determiner 146 determines that the rainwater or the like on the road that is being flung up by the preceding vehicle m affects the recognizer 130. Next, the determiner 146 determines whether or not it is raining in the region in which the subject vehicle M is present on the basis of the weather information acquired in step S101 (step S114). In a case where it is determined that it is not raining by the determiner 146, the action plan generator 150 sets the inter-vehicle distance to the preceding vehicle m to D2 larger than D1 (step S117). On the other hand, in a case where it is determined that it is not raining by the determiner 146 in step S114, the action plan generator 150 sets the inter-vehicle distance to the preceding vehicle m to D5 that is larger than D1 and smaller than D2 (Step S116). Even in a case where it is determined that the rainwater or the like on the road that is being flung up by the preceding vehicle m affects the recognizer 130, it is possible to set the inter-vehicle distance of a case where it is raining to be smaller than the inter-vehicle distance of a case where it is not raining (for example, immediately after precipitation), by using the third determination process. Therefore, it is possible to create a suitable inter-vehicle distance for preventing the detection surface of the finder 14 or the like (or the radar device 12) from being contaminated.

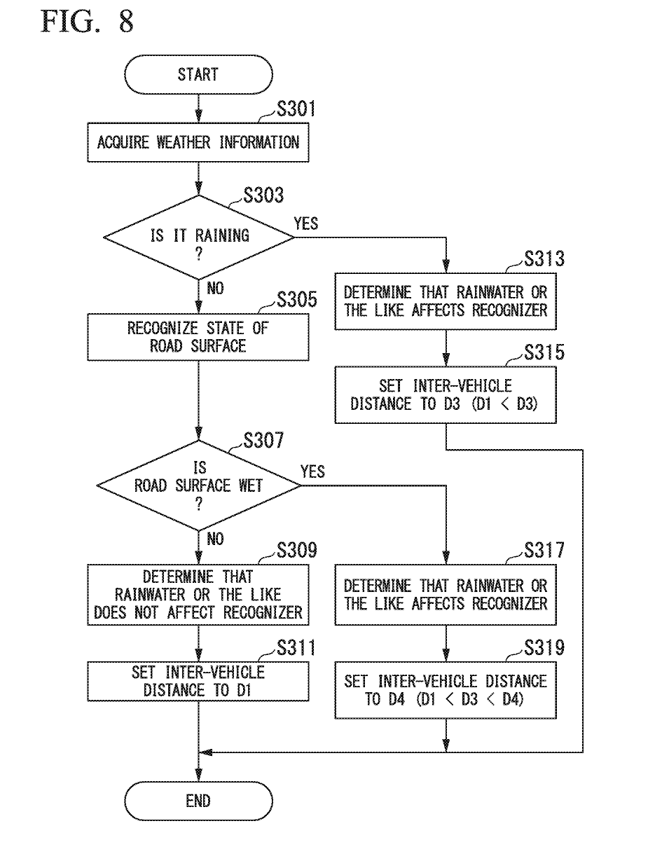

Next, an example of a fourth determination process by the first controller 120 will be described with reference to FIG. 8. First, the acquirer 142 acquires the weather information of the region in which the subject vehicle M is present (step S301). In addition, the determiner 146 determines whether or not it is raining in the region in which the subject vehicle M is present on the basis of the weather information acquired by the acquirer 142 (step S303). In a case where it is determined that it is not raining, the state recognizer 144 recognizes the road surface state of the front side on the subject vehicle M (step S305). The determiner 146 determines whether or not the state in which the road surface is wet is recognized by the state recognizer 144 (step S307). In a case where it is determined that the state in which the road surface is wet is not recognized, the determiner 146 determines that the rainwater or the like on the road that is being flung up by the preceding vehicle m does not affect the recognizer 130 (step S309). The action plan generator 150 sets the inter-vehicle distance to the preceding vehicle m to D1 on the basis of the determination result by the determiner 146 (step S311).

On the other hand, in step S303, in a case where it is determined that it is raining, the determiner 146 determines that the rainwater or the like on the road that is being flung up by the preceding vehicle m affects the recognizer 130 (step S313). The action plan generator 150 sets the inter-vehicle distance to the preceding vehicle m to D3 larger than D1 on the basis of the determination result by the determiner 146 (step S315).

In step S307, in a case where it is determined that the state in which the road surface is wet is recognized, the determiner 146 determines that the rainwater or the like on the road that is being flung up by the preceding vehicle m affects the recognizer 130 (step S317). The action plan generator 150 sets the inter-vehicle distance to the preceding vehicle m to D4 larger than D3 on the basis of the determination result by the determiner 146 (step S319).

Therefore, it is possible to create a suitable inter-vehicle distance for preventing the detection surface of the finder 14 from being contaminated by setting the inter-vehicle distance of a case where it is raining to be smaller than a case where it is not raining in a state in which the road surface is wet, by using the fourth determination process.

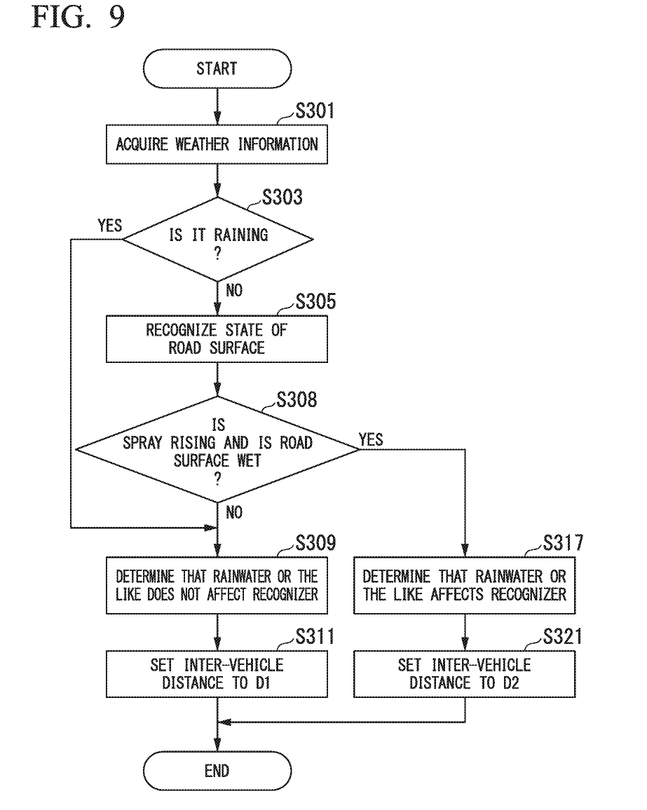

Next, an example of a fifth determination process by the first controller 120 will be described with reference to FIG. 9. The same processes as those in the fourth determination process are denoted by the same reference numerals, and a detailed description thereof will be omitted. In step S303, in a case where it is determined that it is raining, the determiner 146 determines that the rainwater or the like on the road that is being flung up by the preceding vehicle m does not affect the recognizer 130 (step S309). The action plan generator 150 sets the inter-vehicle distance to the preceding vehicle m to D1 on the basis of the determination result by the determiner 146 (step S311).

On the other hand, in step S303, in a case where it is determined that it is not raining, the state recognizer 144 recognizes the road surface state of the front side on the subject vehicle M (step S305). The determiner 146 determines whether or not the state in which the spray is rising in the vicinity of the tire of the preceding vehicle m is recognized and the state in which the road surface is wet is recognized by the state recognizer 144 (step S308). In a case where it is determined that the state in which the spray is rising in the vicinity of the tire of the preceding vehicle m is not recognized or in a case where it is determined that the state in which the road surface is wet is not recognized, steps 5309 and 5311 are executed.

On the other hand, in step S308, in a case where it is determined that the state in which the spray is rising in the vicinity of the tire of the preceding vehicle m is recognized and in a case where it is determined that the state in which the road surface is wet is recognized, the determiner 146 determines that the rainwater or the like on the road that is being flung up by the preceding vehicle m affects the recognizer 130 (step S317). The action plan generator 150 sets the inter-vehicle distance to the preceding vehicle m to D2 larger than D1 on the basis of the determination result by the determiner 146 (step S321).

In a case where it is recognized that the preceding vehicle m is stirring up the spray and immediately after the rain, it is possible to set the inter-vehicle distance to be larger than in a case where it is not so by using the fifth determination process. Therefore, it is possible to create a suitable inter-vehicle distance for preventing the detection surface of the finder 14 from being contaminated. In a case where it is raining, since the rainwater or the like on the road that is being flung up by the preceding vehicle m may not affect the recognizer 130 in some cases, in this case, it is possible to create a suitable inter-vehicle distance for preventing the detection surface of the finder 14 from being contaminated by not changing the inter-vehicle distance.

The process in step S308 may be a process of determining only whether or not the state in which the road surface is wet is recognized. Therefore, in a case where the road surface is wet and it is not raining, the determiner 146 determines that the rainwater or the like on the road that is being flung up by the preceding vehicle m affects the recognizer 130. In addition, the action plan generator 150 is able to set the inter-vehicle distance to be larger than a case where it is determined that the rainwater or the like on the road that is being flung up by the preceding vehicle m does not affect the recognizer 130. In a case where the road surface is wet, even in a state in which the preceding vehicle m is not raising the spray, the spray may rise in a case where the preceding vehicle m travels a portion of the road where the water is low and is partially stagnated in some cases. It is possible to determine that the rainwater or the like on the road that is being flung up by the preceding vehicle m affects the recognizer 130 in consideration of such a case by adopting the constitution described above.

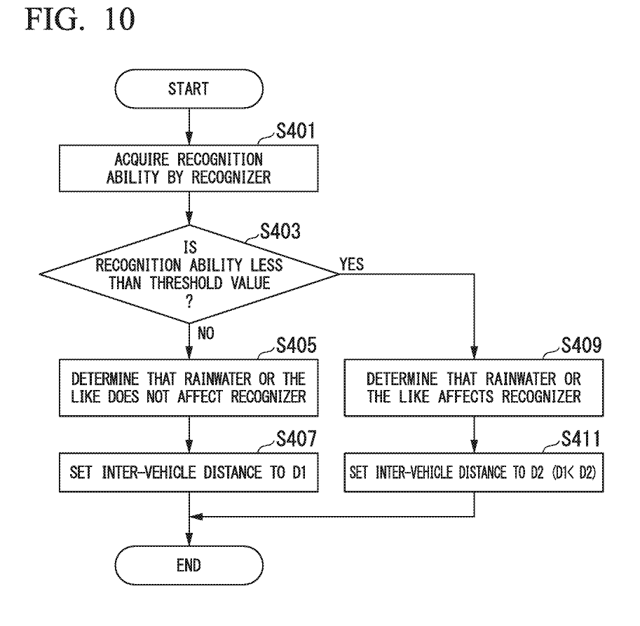

Next, an example of a sixth determination process by the first controller 120 will be described with reference to FIG. 10. First, the acquirer 142 acquires the information indicating the degree of the recognition ability by the recognizer 130 (step S401). The determiner 146 determines whether or not the acquired degree of the recognition ability is less than the threshold value (step S403). In a case where the recognition ability is not less than the threshold value, the determiner 146 determines that the rainwater or the like on the road that is being flung up by the preceding vehicle m does not affect the recognizer 130 (step S405). The action plan generator 150 sets the inter-vehicle distance to the preceding vehicle m to D1 on the basis of the determination result by the determiner 146 (step S407).

On the other hand, in step S403, in a case where it is determined that the acquired degree of the recognition ability is less than the threshold value, the determiner 146 determines that the rainwater or the like on the road that is being flung up by the preceding vehicle m affects the recognizer 130 (step S409). The action plan generator 150 sets the inter-vehicle distance to the preceding vehicle m to D2 larger than D1 on the basis of the determination result by the determiner 146 (step S411). It is possible to determine whether or not the rainwater or the like on the road that is being flung up by the preceding vehicle m affects the recognizer 130 according to whether or not the finder 14 is actually contaminated due to the rainwater or the like that is being flung up by the preceding vehicle m, by using the sixth determination process.

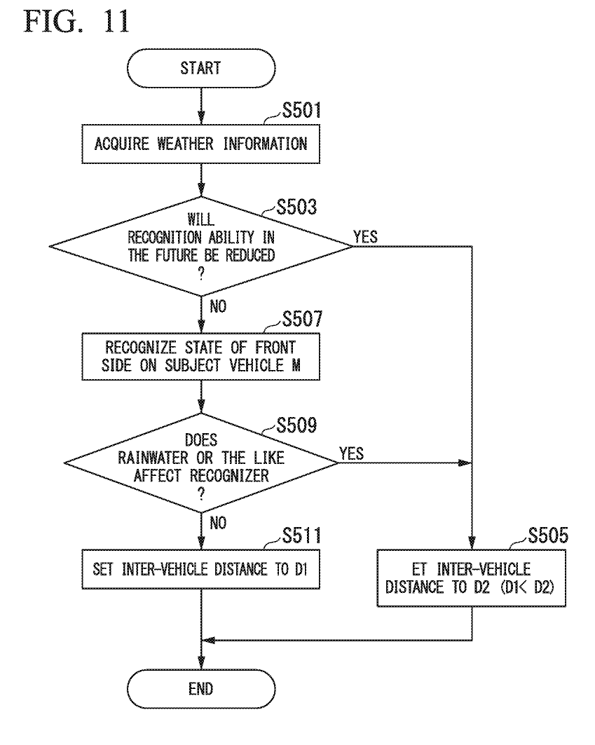

Next, an example of a seventh determination process by the first controller 120 will be described with reference to FIG. 11. First, the acquirer 142 acquires the weather information of the region in which the subject vehicle M is present (step S501). In addition, the determiner 146 determines whether or not the recognition ability by the recognizer 130 in the future will be reduced due to the flung-up rainwater or the like on the basis of the weather information acquired by the acquirer 142 (step S503). In a case where it is determined that the recognition ability by the recognizer 130 in the future will be reduced by the determiner 146, the action plan generator 150 sets the inter-vehicle distance to the preceding vehicle m to D2 larger than D1 (step S505).

On the other hand, in step S503, in a case where it is determined that the recognition ability by the recognizer 130 in the future will not be reduced by the determiner 146, the state recognizer 144 recognizes the state of the front side on the subject vehicle M (step S507). The determiner 146 determines whether or not the rainwater or the like on the road that is being flung up by the preceding vehicle m affects the recognizer 130 on the basis of the recognition result by the state recognizer 144 (step S509). In a case where the state in which the spray is rising in the vicinity of the tire of the preceding vehicle m is recognized (or in a case where the state in which the road surface is wet is recognized) by the state recognizer 144, the determiner 146 determines that the rainwater or the like on the road that is being flung up by the preceding vehicle m affects the recognizer 130. The action plan generator 150 sets the inter-vehicle distance to the preceding vehicle m to D2 larger than D1 on the basis of the determination result by the determiner 146 (step S505).

On the other hand, in step S509, in a case where the state in which the spray is rising in the vicinity of the tire of the preceding vehicle m is not recognized (or in a case where the state in which the road surface is wet is not recognized) by the state recognizer 144, the action plan generator 150 sets the inter-vehicle distance to the preceding vehicle m to D1 (step S509). Regardless of the result of the determination whether or not the rainwater or the like on the road that is being flung up by the preceding vehicle m affects the recognizer 130, in a case where it is determined that the recognition ability by the recognizer 130 in the future will be reduced, it is possible to increase the inter-vehicle distance by using the seventh determination process. Therefore, it is possible to lengthen a period of time until the finder 14 is cleaned.

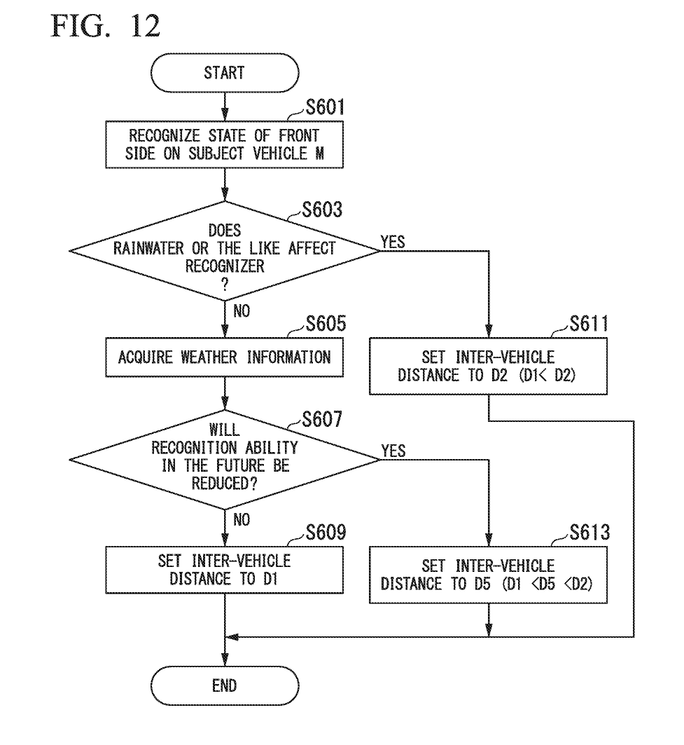

Next, an example of an eighth determination process by the first controller 120 will be described with reference to FIG. 12. First, the state recognizer 144 recognizes the state of the front side on the subject vehicle M (step S601). The determiner 146 determines whether or not the rainwater or the like on the road that is being flung up by the preceding vehicle m affects the recognizer 130 on the basis of the recognition result by the state recognizer 144 (step S603). In a case where the state in which the spray is rising in the vicinity of the tire of the preceding vehicle m is not recognized (or in a case where the state in which the road surface is wet is not recognized) by the state recognizer 144, the determiner 146 determines that the rainwater or the like on the road that is being flung up by the preceding vehicle m does not affect the recognizer 130. In addition, the acquirer 142 acquires the weather information of the region in which the subject vehicle M is present (step S605). In addition, the determiner 146 determines whether or not the recognition ability by the recognizer 130 in the future will be reduced due to the flung-up rainwater or the like on the basis of the weather information acquired by the acquirer 142 (step S607). In a case where it is determined that the recognition ability by the recognizer 130 in the future will not be reduced by the determiner 146, the action plan generator 150 sets the inter-vehicle distance to the preceding vehicle m to D1 (step S609).

On the other hand, in step S503, in a case where the state in which the spray is rising in the vicinity of the tire of the preceding vehicle m is recognized (or in a case where the state in which the road surface is wet is recognized) by the state recognizer 144, the determiner 146 determines that the rainwater or the like on the road that is being flung up by the preceding vehicle m affects the recognizer 130. The action plan generator 150 sets the inter-vehicle distance to the preceding vehicle m to D2 larger than D1 on the basis of the determination result by the determiner 146 (step S611).

In step S507, in a case where it is determined that recognition ability by the recognizer 130 in the future will be reduced by the determiner 146, the action plan generator 150 sets the inter-vehicle distance to the preceding vehicle m to D5 that is larger than D1 and smaller than D2 (Step S613). Even in a case where the rainwater or the like on the road that is being flung up by the preceding vehicle m does not affect the recognizer 130, it is possible to determine whether or not the recognition ability in the future will be reduced according to the weather information and it is possible to increase the inter-vehicle distance according to the determination result, by using the eighth determination process. Therefore, it is possible to lengthen a period of time until the finder 14 is cleaned.

According to the vehicle control device of the first embodiment described above, the recognizer 130 configured to recognize the preceding vehicle m that is in front of the subject vehicle M, the determiner 146 configured to determine whether or not the rainwater or the like on the road that is being flung up by the preceding vehicle m affects the recognizer 130 on the basis of the recognition state of the front side on the subject vehicle M when the preceding vehicle m is recognized by the recognizer 130, and the driving controllers 150 and 160 configured to control the speed of the subject vehicle M to increase the relative distance between the subject vehicle M and the preceding vehicle m in a case where it is determined that the rainwater or the like on the road that is being flung up by the preceding vehicle m affects the recognizer 130 by the determiner 146 are provided. Therefore, in a case where the rainwater or the like on the road that is being flung up by the preceding vehicle m affects the recognizer 130, it is possible to travel away from the preceding vehicle m. Thus, it is possible to devise control for preventing the finder 14 from being contaminated due to the flung-up minute object by the preceding vehicle m.

### Second Embodiment

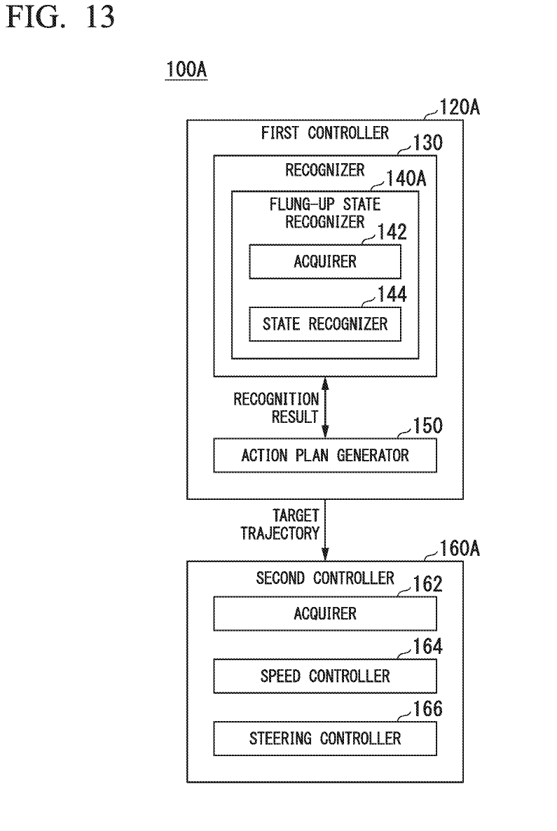

Next, an example of the automated driving control device 100A according to the embodiment will be described with reference to FIG. 13. FIG. 13 is a functional constitution diagram of the automated driving control device 100A according to the embodiment. The automated driving control device 100A includes a first controller 120A and a second controller 160A. The recognizer 130 of the first controller 120A includes a flung-up state recognizer 140A. The flung-up state recognizer 140A is different from the flung-up state recognizer 140 according to the first embodiment in that the flung-up state recognizer 140A does not include the determiner 146. The action plan generator 150 adjusts the inter-vehicle distance between the subject vehicle M and the preceding vehicle m on the basis of the recognition result by the state recognizer 144. The same constitutions are denoted by the same reference numerals, and a detailed description thereof will be omitted.

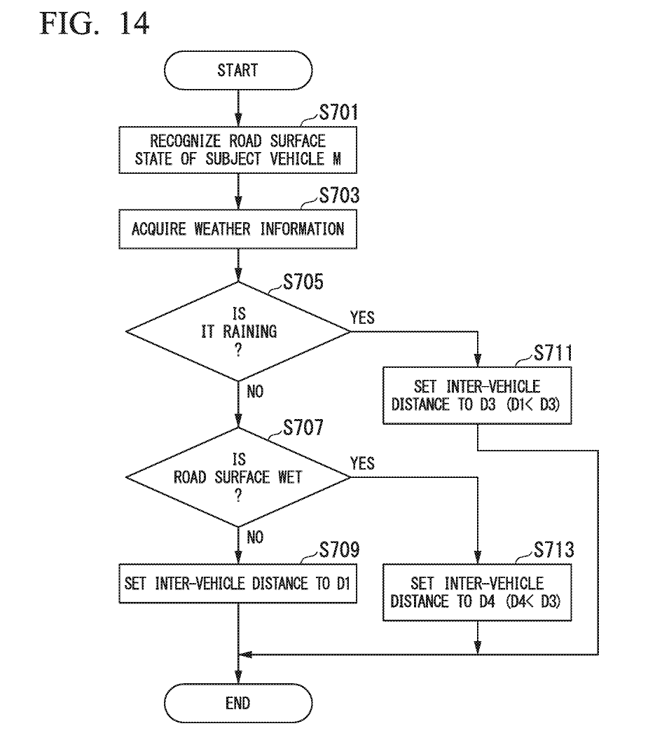

Next, a process example by the first controller 120A will be described with reference to FIG. 14. FIG. 14 is a flowchart illustrating an example of a flow of the ninth determination process executed by the first controller 120A. First, the state recognizer 144 recognizes the road surface state of the front side on the subject vehicle M (step S701). In a case where the state recognizer 144 recognizes that the road surface is wet, the state recognizer 144 outputs information indicating that the road surface is wet to the action plan generator 150. Next, the acquirer 142 acquires the weather information of the region in which where the subject vehicle M is present (step S703). In a case where the acquired weather information includes the fact that it is raining, the acquirer 142 outputs information indicating that it is raining to the action plan generator 150.

The action plan generator 150 determines whether or not the information indicating that it is raining is input from the acquirer 142 (step S705). In a case where the information indicating that it is raining is not input, the action plan generator 150 determines whether or not the information indicating that the road surface is wet is input from the state recognizer 144 (step S707). In a case where the information indicating that the road surface is wet is not input, the action plan generator 150 sets the inter-vehicle distance to the preceding vehicle m to D1 (step S709).

On the other hand, in step S705, in a case where the information indicating that it is raining is input, the action plan generator 150 sets the inter-vehicle distance to the preceding vehicle m to D3 larger than D1 (step S711). In step S707, in a case where the information indicating that the road surface is wet is input, the action plan generator 150 sets the inter-vehicle distance to the preceding vehicle m to D3 that is larger than D1 and is smaller than D4 (step S713).

According to the vehicle control device of the present embodiment described above, the recognizer 130 configured to recognize the preceding vehicle m that is present on the front side of the subject vehicle M, the state recognizer 144 configured to recognize the state of the road surface, the acquirer 142 configured to acquire the weather information of the region in which the subject vehicle M is present, and the driving controllers 150 and 160 configured to control the speed of the subject vehicle M so as to increase the relative distance between the subject vehicle M and the preceding vehicle m in a case where it is recognized that the road surface is wet by the state recognizer 144 and it is not raining, as compared with a case where it is not recognized that the road surface is wet by the state recognizer 144 or it is raining are provided. Therefore, in a case where a possibility that the preceding vehicle m is stirring up the minute object is high and a possibility that the flung-up minute object or the like is not washed away by the rain is high, it is possible to travel the subject vehicle M farther than the preceding vehicle m as compared with a case where it is not so.

### Third Embodiment

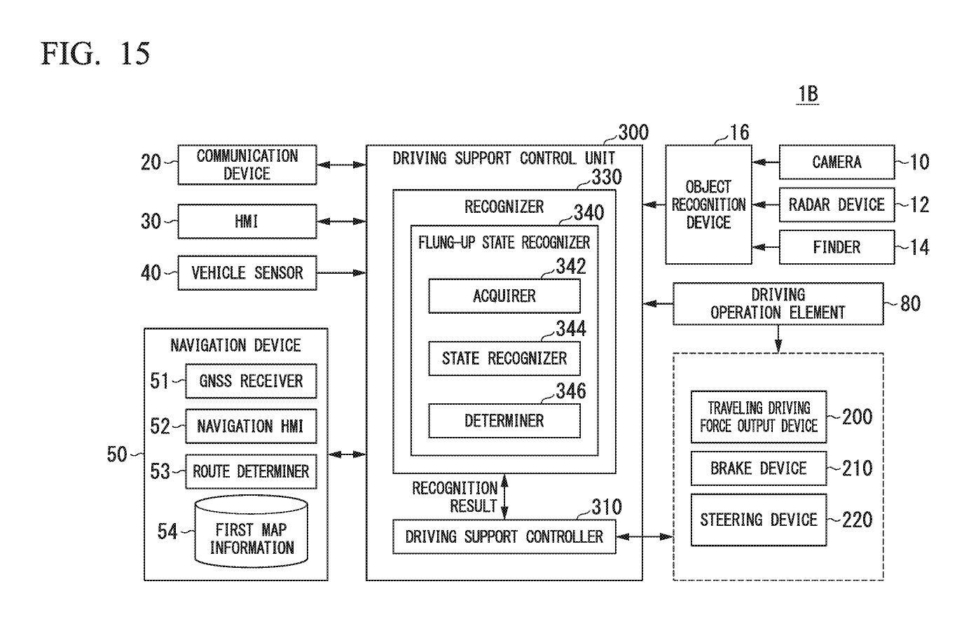

An example in which part of the recognizer 130 and the driving controllers 150 and 160 having the same function and constitution as those of the above-described first controller 120 is used in the vehicle having the driving support function will be described below with reference to FIG. 15.

FIG. 15 is a constitution diagram of a vehicle system 1B using the vehicle control device according to the embodiment in the vehicle having the driving support function. Descriptions of the same function and constitution as those of the vehicle system 1 are omitted. For example, the vehicle system 1B includes a driving support control unit 300 in place of a part of the constitution included in the vehicle system 1. The driving support control unit 300 includes a recognizer 330 and a driving support controller 310. The recognizer 330 includes a flung-up state recognizer 340. The flung-up state recognizer 340 includes an acquirer 342, a state recognizer 344, and a determiner 346. These constitutions have the same functions as the acquirer 142, the state recognizer 144, and the determiner 146. The constitution shown in FIG. 15 is merely an example, and a part of the constitution may be omitted, or another constitution may be added.

The driving support controller 310 has functions such as a lane keeping assist system (LKAS), an adaptive cruise control system (ACC), an auto lane change system (ALC), and the like. In a case where the driving support controller 310 is performing control to keep the inter-vehicle distance to the preceding vehicle m constant, the driving support controller 310 adjusts the inter-vehicle distance by the same rule as the embodiment described above.

According to the vehicle control device of the third embodiment described above, it is possible to obtain the same effects as those of the first embodiment.

<Hardware Constitution>

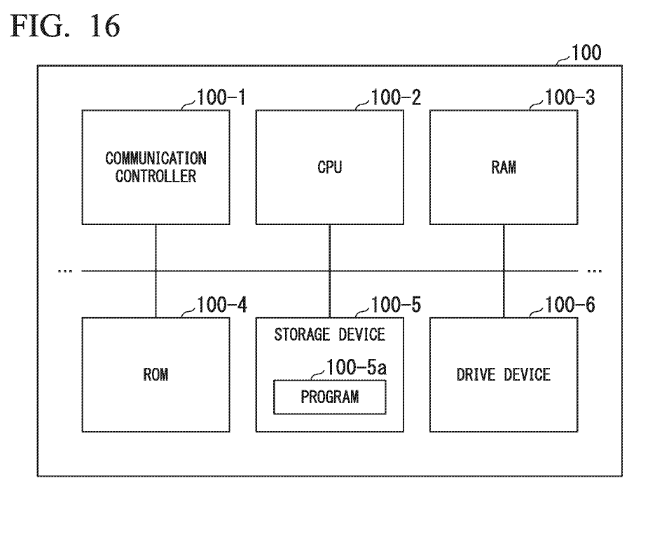

The vehicle control device of the embodiment described above is realized, for example, by a hardware constitution as shown in FIG. 16. FIG. 16 is a diagram illustrating an example of the hardware constitution of the vehicle control device according to the embodiment.

The vehicle control device includes a communication controller 100-1, a CPU 100-2, a RAM 100-3, a ROM 100-4, a secondary storage device 100-5 such as a flash memory or an HDD, and a drive device 100-6 that are mutually connected by an internal bus or a dedicated communication line. A portable storage medium such as an optical disk is installed in on the drive device 100-6. The program 100-5a stored in the secondary storage device 100-5 is developed in the RAM 100-3 by a DMA controller (not shown) or the like and executed by the CPU 100-2, whereby the vehicle control device is realized. The program referred to by the CPU 100-2 may be stored in a portable storage medium installed to the drive device 100-6 or may be downloaded from another device through a network NW.

The embodiment described above is able to be expressed as follows.

A vehicle control device including:

a storage device; and

a hardware processor configured to execute a program stored in the storage device,

wherein the hardware processor executes the program to:

recognize a preceding vehicle that is in front of a subject vehicle on the basis of information collected by an information collection unit including an information collection surface oriented toward an outside of the subject vehicle;

determine whether or not an aspect of the front side on the subject vehicle satisfies a predetermined condition on the basis of a recognition result and determine whether or not rainwater or the like (a minute object) on a road that is being flung up by the preceding vehicle affects a recognition accuracy of the preceding vehicle by adhering to the information collection surface in a case where the aspect of the front side on the subject vehicle satisfies the predetermined condition; and

control a speed of the subject vehicle so as to increase a relative distance between the subject vehicle and the preceding vehicle in a case where it is determined that the rainwater or the like on the road that is being flung up by the preceding vehicle affects the recognition accuracy of the preceding vehicle by adhering to the information collection surface.

Although the embodiments for carrying out the present invention have been described above using the embodiments, the present invention is not limited to these embodiments at all, and various modifications and substitutions can be added without departing from the spirit of the present invention.

For example, in a case where the determiner 146 determines that the rainwater or the like on the road that is being flung up by the preceding vehicle m affects the recognizer 130, the determiner 146 may derive a flung-up degree. For example, the flung-up degree may be expressed at a stage defined by numerals (for example, 1 to 3), or may be expressed by high, low, and the like. For example, in a case where a size or a height of the spray of the rainwater that is being flung up by the state recognizer 144 are recognized, the determiner 146 may derive the flung-up degree according to the size or the height of the spray. In a case where the weather information is acquired by the acquirer 142, the determiner 146 may derive the flung-up degree according to the amount of precipitation included in the weather information. In a case where the information indicating the recognition ability by the recognizer 130 is obtained by the acquirer 142, the determiner 146 may derive the flung-up degree according to the degree of the recognition ability. In addition, the action plan generator 150 may set different inter-vehicle distances according to the flung-up degree derived by the determiner 146. For example, the action plan generator 150 may control the speed of the subject vehicle M so that the inter-vehicle distance of a case where the flung-up degree is high is higher than a case where the flung-up degree is low.

The function of acquiring the recognition ability of the object recognition device 16 in the acquirer 142 may be mounted on the object recognition device 16.

What is claimed is:

1. A vehicle control device comprising:
a recognizer configured to recognize a preceding vehicle in front of a subject vehicle on the basis of information collected by an information collection unit including an information collection surface oriented toward an outside of the subject vehicle;
a determiner configured to determine whether or not a situation in front of the subject vehicle satisfies a predetermined condition on the basis of a recognition result by the recognizer, and determine that a minute object on a road that is being flung up by the preceding vehicle affects a recognition accuracy of the recognizer by adhering to the information collection surface in a case where the situation in front of the subject vehicle satisfies the predetermined condition; and
a driving controller configured to control a speed of the subject vehicle to increase a relative distance between the subject vehicle and the preceding vehicle in a case where it is determined by the determiner that the minute object on the road that is being flung up by the preceding vehicle affects the recognition accuracy of the preceding vehicle by adhering to the information collection surface.

2. The vehicle control device of claim 1, further comprising:
an acquirer configured to acquire weather information of a region in which the subject vehicle is present,
wherein the determiner further determines whether or not the minute object on the road that is being flung up by the preceding vehicle affects the recognizer on the basis of the weather information acquired by the acquirer.

3. The vehicle control device of claim 2,
wherein the determiner determines whether or not a recognition ability by the recognizer in the future will be reduced by the flung-up minute object on the basis of the weather information, and
in a case where it is determined by the determiner that the recognition ability by the recognizer in the future will be reduced by the flung-up minute object, the driving controller controls the speed of the subject vehicle to increase the relative distance.

4. The vehicle control device of claim 1,
wherein the recognizer further recognizes a state of a road surface, and
in a case where it is recognized by the recognizer that the road surface is wet and it is not raining, the determiner determines that the minute object on the road that is being flung up by the preceding vehicle affects the recognizer.

5. The vehicle control device of claim 1,
wherein, in a case where a recognition ability by the recognizer is less than a threshold value, the determiner determines that the minute object on the road that is being flung up by the preceding vehicle affects the recognizer.

6. The vehicle control device of claim 1,
wherein the determiner determines whether or not precipitation has just ended and determines whether or not precipitation is ongoing on the basis of weather information of a region in which the subject vehicle is present, and
in a case where it is determined by the determiner that the minute object on the road that is being flung up by the preceding vehicle affects the recognizer and precipitation has just ended, the driving controller controls the speed of the subject vehicle to increase the relative distance between the subject vehicle and the preceding vehicle as compared with a case where it is determined that the minute object on the road that is being flung up by the preceding vehicle affects the recognizer and precipitation is ongoing.

7. A vehicle control device comprising:
a recognizer configured to recognize a preceding vehicle in front of a subject vehicle and a state of a road surface on the basis of information collected by an information collection unit including an information collection surface oriented toward an outside of the subject vehicle;
an acquirer configured to acquire weather information of a region in which the subject vehicle is present; and
a driving controller configured to control a speed of the subject vehicle to increase a relative distance between the subject vehicle and the preceding vehicle in a case where it is recognized that by the recognizer the road surface is wet and it is not raining, as compared with a case where it is not recognized by the recognizer that the road surface is wet or it is raining.

8. A vehicle control method executed by an in-vehicle computer that is mounted in a vehicle, the vehicle control method by the in-vehicle computer comprising:
recognizing a preceding vehicle in front of a subject vehicle on the basis of information collected by an information collection unit including an information collection surface oriented toward an outside of the subject vehicle;
determining whether or not a situation in front side on the subject vehicle satisfies a predetermined condition on the basis of a recognition result;
determining that a minute object on a road that is being flung up by the preceding vehicle affects a recognition accuracy of the preceding vehicle by adhering to the information collection surface in a case where the situation in front of the subject vehicle satisfies the predetermined condition; and
controlling a speed of the subject vehicle to increase a relative distance between the subject vehicle and the preceding vehicle in a case where it is determined that the minute object on the road that is being flung up by the preceding vehicle affects the recognition accuracy of the preceding vehicle by adhering to the information collection surface.

9. A computer-readable non-transitory storage medium storing a program that causes an in-vehicle computer to:
recognize a preceding vehicle in front of a subject vehicle on the basis of information collected by an information collection unit including an information collection surface oriented toward an outside of the subject vehicle;
determine whether or not a situation in front of the subject vehicle satisfies a predetermined condition on the basis of a recognition result;
determine that a minute object on a road that is being flung up by the preceding vehicle affects a recognition accuracy of the preceding vehicle by adhering to the information collection surface in a case where the situation in front of the subject vehicle satisfies the predetermined condition; and
control a speed of the subject vehicle to increase a relative distance between the subject vehicle and the preceding vehicle in a case where it is determined that the minute object on the road that is being flung up by the preceding vehicle affects the recognition accuracy of the preceding vehicle by adhering to the information collection surface.
